(19) United States
(12) Patent Application Publication
(10) Pub. No.: US 2019/0311481 A1
(43) Pub. Date: Oct. 10, 2019

(54) Classification of Static Objects With a Mobile Camera

(71) Applicant: ZF FRIEDRICHSHAFEN AG, Friedrichshafen (DE)

(72) Inventor: Alexander Stohr, Lindau (DE)

(73) Assignee: ZF FRIEDRICHSHAFEN AG, Friedrichshafen (DE)

(21) Appl. No.: 16/335,639

(22) PCT Filed: Aug. 8, 2017
(86) PCT No.: PCT/EP2017/070000

§ 371 Date: Mar. 21, 2019

(30) Foreign Application Priority Data
Sep. 22, 2016 (DE) 10 2016 218 213.7

(51) Int. Cl. G06T 7/20; G06K 9/62; H04N 5/225

(52) U.S. Cl. CPC G06T 7/20; G06T 2207/30252; H04N 5/225; G06K 9/62

(57) ABSTRACT

The invention relates to an assembly that has at least one camera (101), at least one evaluation unit (303), and at least one sensor (301), wherein the camera (101) is configured to record a first image (105) and a second image (201), wherein the sensor (301) is configured to detect movements of the camera (101), wherein the evaluation unit (303) is configured to identify at least one object (103) recorded in the first image (105) and the second image (201), and to classify it as moving or stationary. The classification of the object (103) takes place taking the movement of the camera into account (101).

The invention relates to an assembly according to the preamble of claim 1 and a method according to the independent method claim.

Various applications from the field of autonomous driving require that moving objects be distinguished from stationary objects in video images. This is problematic when the camera itself is moving, such as when it is mounted in a moving vehicle. As a result of camera movements, stationary objects also appear to be moving in the video image.

U.S. Pat. No. 4,959,725 discloses an image stabilizer. The video camera is provided with movement sensors, the signals from which are used to stabilize blurred video images. This takes place in that the accelerations registered by the sensors that exceed a predefined threshold are used to compute a stabilized video image, in which the accelerations have been removed. Accelerations below the threshold, occurring when the camera is intentionally pivoted, are ignored.

With an image stabilizer, high frequency disruptive movements of the camera can be filtered out. An image stabilizer has no effect on low frequency movements.

The fundamental object of the invention is to reliably classify moving and stationary objects in a camera image. In particular, the classification should be possible despite low frequency movements of the camera.

This object is achieved by an assembly according to claim 1 and a method according to the independent method claim. Preferred further developments are contained in the dependent claims.

The assembly comprises at least one camera, at least one evaluation unit, and at least one sensor.

A camera is a device in general for generating images of objects. The images are normally two dimensional, i.e. they extend over precisely two spatial dimensions. The camera records electromagnetic beams emitted from the objects, e.g. through reflection. The recorded beams are converted by the camera into images.

The camera according to the invention is a film camera. This is distinguished in that it records moving images. A moving image is a sequence of images, comprising a first image and a second image in the present case.

The sensor is configured to detect movements of the camera in relation to a stationary reference system. In particular, movements of the camera between the time at which the first image is recorded and the time at which the second image is recorded are detected. One or more acceleration sensors can be used to detect the movement of the camera, which are rigidly connected to the camera, i.e. they are unable to move in relation to the camera.

The evaluation unit is configured to identify at least one object recorded by the camera in the first image and the second image, and to classify this object as moving or stationary. Classification in this sense means the placement of the object in a group of moving objects or a group of stationary objects.

Moving objects are those objects the move in the stationary reference system. Stationary objects are those that remain in place, and do not move in the stationary reference system.

If the object is recorded by the camera when the camera records the first image and when the camera records the second image, then both the first image as well as the second image contain an image of the object. These images are identified by the evaluation unit. In doing so, components of the first image and second image belonging to the respective images are identified.

The object is classified as moving when it moves in relation to the stationary reference system between the time at which the first image is recorded and the time at which the second image is recorded. Otherwise, i.e. when the object does not move in relation to the stationary reference system between the time at which the first image is recorded and the time at which the second image is recorded, it is classified as stationary.

According to the invention, the evaluation unit is configured to classify the objects taking into account the movements of the camera detected by the sensor. By taking the movements of the camera into account, it is possible to reliably classify stationary objects despite the movement of the camera.

In a preferred further development, the object is classified as stationary when a deviation between its position or its image in the first image and the second image is caused exclusively by the movements of the camera. The evaluation unit checks whether a deviation in the position of the object in the first image and the position of the object in the second image can be attributed to the movement of the camera detected by the sensors, or whether the deviation is also due to movement of the object itself. In the latter case, the object is classified as moving.

The evaluation unit can compute the deviation in the position of a hypothetical object that is assumed to be stationary, taking into account the movements of the camera. The deviations are computed relatively or absolutely in alternative preferred further developments.

A relative computation takes place in that the evaluation unit computes a hypothetic deviation between the position of the object in the first image and the second image based on the movement of the camera, assuming that the object is stationary. This is possible because the deviation in the case of a stationary object depends exclusively on the movements of the camera. These are detected by the sensor, and supplied to the evaluation unit. If there is an actual deviation between the positions of the object in the first image and second image, i.e. a deviation between an actual position of the object in the first image and an actual position of the object in the second image is identical to the hypothetical deviation, the object is classified as stationary. If these deviations are not identical, the evaluation unit classifies the object as moving.

Based on a position of the object in the first image, the evaluation unit computes an absolute position deviation in the form of a hypothetical position of the object in the second image, assuming that the object is stationary. The position of the object in the first image is the actual position of the object or its image. Based on this, the camera computes the expected position of a stationary object in the second image, taking into account the movements of the camera detected by the sensor. The evaluation unit thus assumes that the stationary object is located in the first image in the position of the identified object, and computes the position of the stationary object in the second image based on this. The object is classified as stationary when an actual position of the object in the second image is the same as the hypothetical position, i.e. the computed position of the object that is assumed to be stationary is the same in the second image. If these positions deviate from one another, the object is classified as moving.

The absolute computation can be carried out based on a first image, recorded prior to the second image, as well as based on a second image that is recorded prior to the first image.

In a further development, the assembly has a first means for signal transmission. This transmits signals from the camera to the evaluation unit. The signals are image signals. In particular, the first image and the second image are encoded in the signals that are to be transmitted from the camera to the evaluation unit.

In another further development, the assembly has a second means for signal transmission. This transmits signals from the sensor to the evaluation unit. These are movement signals, in which the movements of the camera detected by the sensors are encoded.

The assembly is preferably part of a vehicle, in particular a motor vehicle. The assembly can be integrated in a driver assistance system. The assembly informs the driver assistance system of the classification of the object as moving or stationary.

A method according to the invention for classifying an object as moving or stationary comprises the following steps:
recording a first image and a second image with a camera, wherein the object is contained in the first image and the second image;
detecting movements of the camera; and
classifying the object as moving or stationary, taking the movements of the camera into account.

The steps are preferably carried out in the given sequence. The method can contain one or more of the steps carried out by the assembly according to the invention, or one of their further developments in preferred further developments.

Preferred exemplary embodiments of the invention are shown in the figures. Identical reference symbols indicate identical features or features having identical functions. Therein:

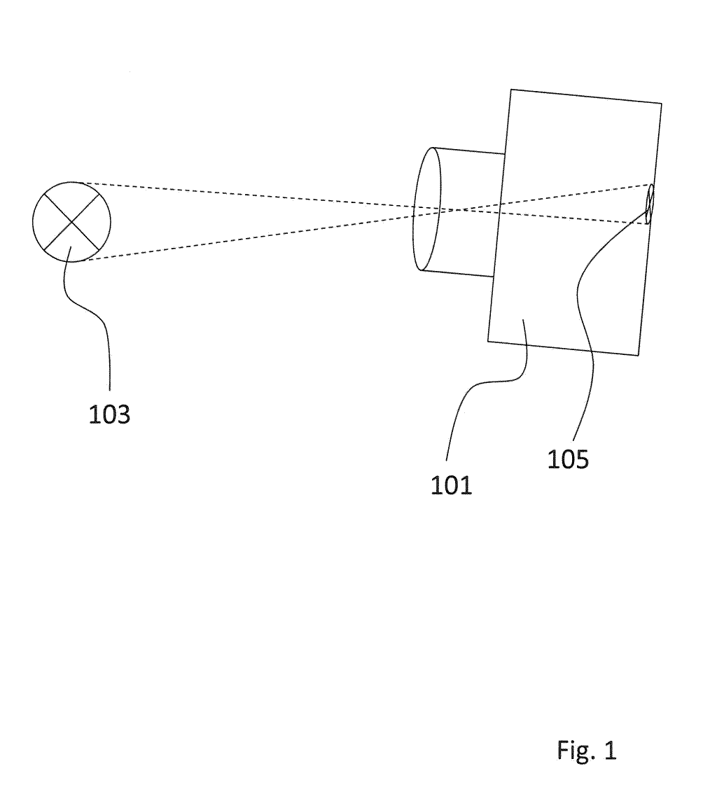

FIG. 1 shows a camera in a first position;

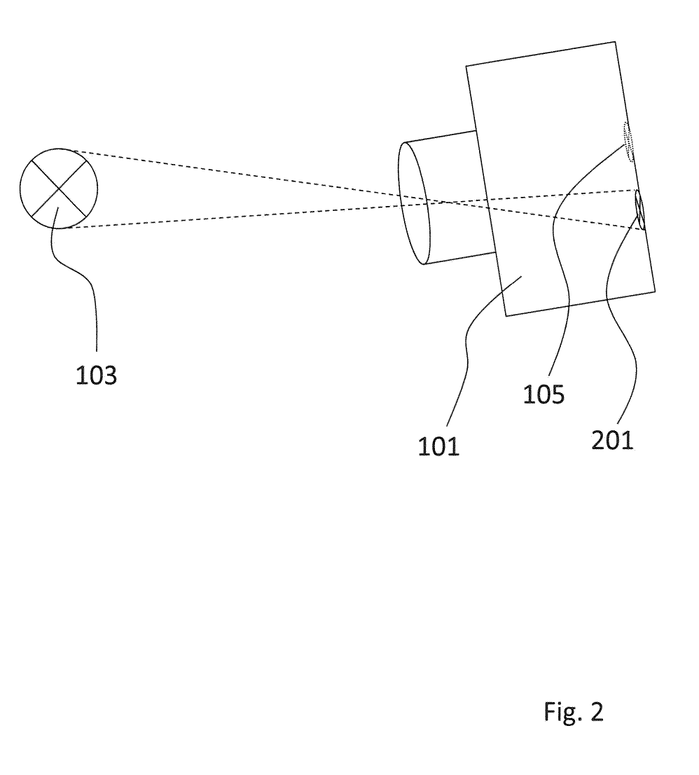

FIG. 2 shows the camera in a second position; and

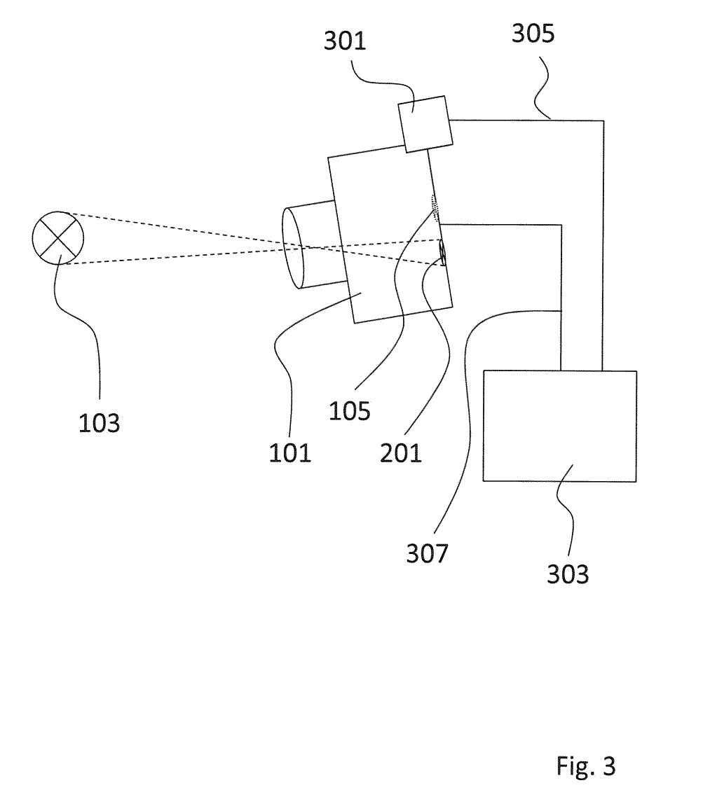

FIG. 3 shows the assembly containing the camera.

The camera 101 shown in FIGS. 1 to 3 is a video camera, i.e. a camera that records moving images. The camera 101 is oriented such that it records an object 103. The camera 101 generates a first image 105 of the object 103 shown in FIG. 1.

In comparison with the position shown in FIG. 1, the camera 101 is tilted in FIG. 2. The camera 101 also records the object 103, but its image is displaced. Accordingly, the position of a second image 201 of the object 103 differs from the position of the first image 105 within an imaging plane of the camera 101.

The assembly shown in FIG. 3 also comprises an acceleration sensor 301 and an evaluation unit 303, in addition to the camera 101. The acceleration sensor 301 is rigidly connected to the camera 101, and thus detects its movements.

The movements of the camera 101 are transmitted to the evaluation unit 303 in the form of a movement signal 305. Furthermore, an image signal 307 is transmitted from the camera 101 to the evaluation unit 303. By comparing the movement signal 305 with the position of the first image 105 and the second image 203 contained in the movement signal 305, the evaluation unit 303 can determine whether the recorded object 103 is a moving or stationary object.

### REFERENCE SYMBOLS

101 camera
103 object
105 first image
201 second image
301 acceleration sensor
303 evaluation unit
305 movement signal
307 image signal

1. An assembly that has at least one camera, at least one evaluation unit, and at least one sensor, wherein the camera is configured to record a first image and a second image, wherein the sensor is configured to detect movements of the camera, and wherein the evaluation unit is configured to identify at least one object recorded by the camera in the first image and in the second image, and to classify the object as moving or stationary, characterized in that the classification of the object takes into account the movements of the camera.

2. The assembly according to claim 1, wherein the object is classified as stationary when a deviation between the position of the object in the first image and the second image is based exclusively on the movements of the camera.

3. The assembly according to claim 2, wherein the evaluation unit computes a hypothetical deviation between the positions of the objects in the first image and the second image, assuming that the object is stationary, wherein the object is classified as stationary when an actual deviation between the positions of the object in the first image and the second image is the same as the hypothetical deviation.

4. The assembly according to claim 2, wherein the evaluation unit computes a hypothetical position of the object in the second image based on a position of the object in the first image and the movements of the camera, assuming that the object is stationary, wherein the object is classified as stationary when an actual position of the object in the second image is the same as the hypothetical position.

5. The assembly according to claim 1, characterized by a first means for signal transmission, wherein the first means is configured to transmit signals from the camera to the evaluation unit.

6. The assembly according to claim 1, characterized by a second means for signal transmission, wherein the second means is configured to transmit signals from the sensor to the evaluation unit.

7. A vehicle with an assembly according to claim 1.

8. A method for classifying an object as moving or stationary, comprising the steps:
recording a first image and a second image with a camera, wherein the object is contained in the first image and the second image;
detecting movements of the camera; and
classifying the object as moving or stationary, taking the movements of the camera into account.

9. The assembly according to claim 2, characterized by a first means for signal transmission, wherein the first means is configured to transmit signals from the camera to the evaluation unit.

10. The assembly according to claim 3, characterized by a first means for signal transmission, wherein the first means is configured to transmit signals from the camera to the evaluation unit.

11. The assembly according to claim 4, characterized by a first means for signal transmission, wherein the first means is configured to transmit signals from the camera to the evaluation unit.

12. The assembly according to claim 2, characterized by a second means for signal transmission, wherein the second means is configured to transmit signals from the sensor to the evaluation unit.

13. The assembly according to claim 3, characterized by a second means for signal transmission, wherein the second means is configured to transmit signals from the sensor to the evaluation unit.

14. The assembly according to claim 4, characterized by a second means for signal transmission, wherein the second means is configured to transmit signals from the sensor to the evaluation unit.

15. The assembly according to claim 5, characterized by a second means for signal transmission, wherein the second means is configured to transmit signals from the sensor to the evaluation unit.

16. A vehicle with an assembly according to claim 2

17. A vehicle with an assembly according to claim 3.

18. A vehicle with an assembly according to claim 4.

19. A vehicle with an assembly according to claim 5.

20. A vehicle with an assembly according to claim 6.
